(19) United States
(12) Patent Application Publication
(10) Pub. No.: US 2001/0030603 A1
(43) Pub. Date: Oct. 18, 2001

(54) SYSTEM FOR ALTERING WHEN SEPARATED BY A PRESET DISTANCE

(76) Inventor: Ms. Susanne Arens, Colorado Springs, CO (US)

Correspondence Address: Mark G. Pannell, Hanes & Schutz, P.C., 7222 Commerce Center Dr., Suite 243, Colorado Springs, CO, 80919, US, mgp@hanesschutz.com, 719-260-7900, 719-260-7904

(21) Appl. No.: 09/604,522

(22) Filed: Jun. 27, 2000

(51) Int. Cl. G08B 29/00

(52) U.S. Cl. 340/506; 340/573.4; 340/686.6

(57) ABSTRACT

### Abstract of Disclosure

A distance is discovered between a first device and a second device. The distance is discovered by any method. One method for discovering the distance is by generating a signal from the first device to the second device and measuring the amplitude of the signal received by the second device then discovering the distance from the measured strength of the signal. A second method for determining the distance is by discovering the location of each device and communicating the location of the first device to the second device where the two locations are compared to realize the difference between the two devices. A third method for determining the distance is by the second device requesting a response from the first device and measuring the time between the request and the receipt of the response. The distance is then discovered from the measured time. However it is discovered, the discovered distance is compared to a preset distance condition. An alarm is activated when the distance condition is met by the discovered distance. The alarm may be audible, visible, or both.

### Background of Invention

The present invention relates in general to location technology, and more particularly to, alarming when the distance between two devices fulfills a preset distance condition.

While underwater, it is very important for divers to keep track of each other. One of the most important rules for scuba divers is to, "always know where your dive buddy is". Because of all the equipment, i.e. mask, snorkel, BCD and tank, scuba divers wear, it is very difficult for them to keep their dive buddy in sight. Scuba diving is an exciting, yet dangerous, sport. Divers can find themselves in several life threatening situations. They can encounter predators or get tangled up in seaweed, wreaks, or amongst their own equipment. It is not uncommon for divers to run out of air or get caught in an undertow. All of these situations can be deadly without the assistance of their dive buddies. Since divers cannot speak to each other underwater, it is often difficult or impossible for a diver to attract the attention of another diver.

Few solutions have been developed to make it easier for divers to keep track of their fellow divers. None of them provide an automated system for alerting a diver when they have been separated from their fellow diver by a fixed distance, or provide an option for the distressed diver to send an alert signal to their dive partner.

### Summary of Invention

According to principles of the present invention, a distance is discovered between a first device and a second device. The discovered distance is compared to a preset distance condition. An alarm is activated when the distance condition is met by the discovered distance or when activated by a user.

According to further principals of the present invention, the distance is discovered by any method. One method for discovering the distance is by generating a signal from the first device to the second device and measuring the amplitude of the signal received by the second device then discovering the distance from the measured amplitude of the signal. A second method for determining the distance is by discovering the location of each device and communicating the location of the first device to the second device where the two locations are compared to realize the difference between the two devices. A third method for determining the distance is by the second device requesting a response from the first device and measuring the time between the request and the receipt of the response. The distance is then discovered from the measured time.

Other objects, advantages, and capabilities of the present invention will become more apparent as the description proceeds.

### Brief Description of Drawings

Figure 1 is a block diagram generally illustrating the system of the present invention.

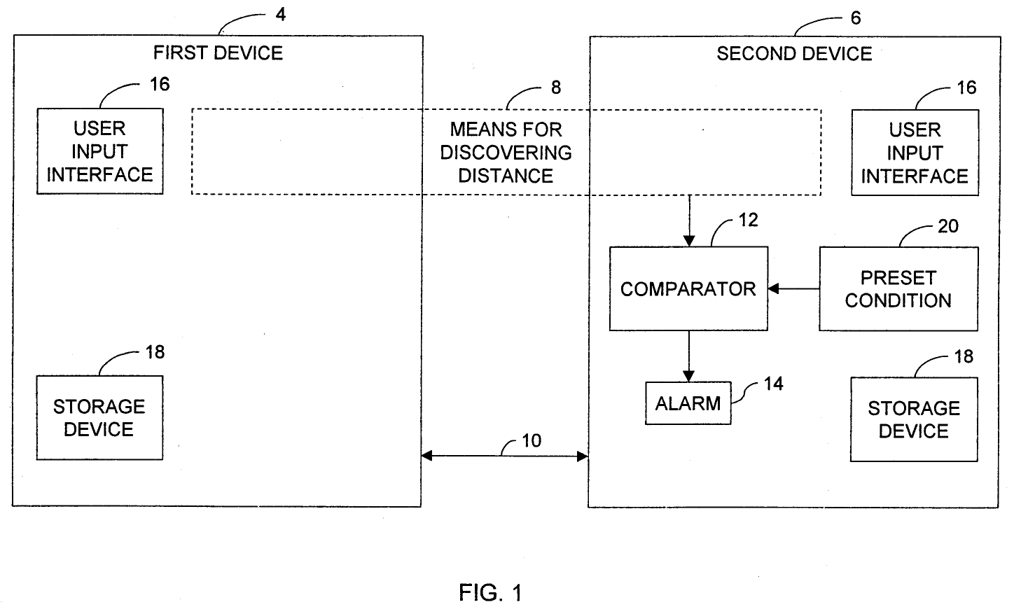

Figure 2 is a flow chart generally illustrating the method of the present invention.

Figure 3 is a block diagram illustrating in more detail one embodiment of the means for discovering distance in Figure 1.

Figure 4 is a flow chart illustrating in more detail the step of discovering distance in Figure 2.

Figure 5 is a block diagram illustrating in more detail one embodiment of the means for discovering distance in Figure 1.

Figure 6 is a flow chart illustrating in more detail the step of discovering distance in Figure 2.

Figure 7 is a block diagram illustrating in more detail one embodiment of the means for discovering distance in Figure 1.

Figure 8 is a flow chart illustrating in more detail the step of discovering distance in Figure 2.

### Detailed Description

9Docket No.: 1182.100Figure 1 illustrates a system 2 for alerting when a first device 4 and a second device 6 are separated by a preset distance. System 2 includes a means 8 for discovering a distance 10 between first device 4 and a second device 6, a comparator 12, and an alarm 14. System 2 may also include various additions such as a user input interface 16 and a storage device 18 for storing a preset distance condition 20 or executable instructions.

First device 4 and second device 6 may be of any shape or design. System 2 may have a variety of uses with each use having its own desired shape. For use in diving, first device 2 and second device 6 are conveniently embodied in a shape to be worn on a diver's wrist or attached to the divers Buoyancy Control Device (BCD). Additionally, when used by divers, it may be desirable for first device 4 and second device 6 to include conventional diving features such as a dive time indicator or other indicators useful for divers.

For clarity, first device 4 and second device 6 are being described as separate devices. In one embodiment of system 2, first device 4 and second device 6 each include all of the components of the other device. In that embodiment, each of two or more divers would be able to keep track of the distance between them.

Comparator 12 is any combination of circuitry and executable instructions able to carry out the function of comparing distance 10 to preset condition 20. As the information describing distance 10 may take a variety of forms, comparator 12 may also be embodied in a variety of ways. For example, if distance 10 is defined within second device 6 as an amplitude, comparator 12 may take the form of an amplitude switch. Alternatively, if distance 10 is defined within second device 6 as a numerical value, comparator 12 may take the form of a processor.

Alarm 14 is any device for alerting a person. For example, alarm 14 may be any type of indication such as an audible, visible, or vibrating alarm.

User input interface 16 is any interface by which a user may interact with either first device 4 or second device 6. For example, user input interface 16 may be one or more buttons, knobs, dials, or switches. User interface 16 may be used to set preset condition 20 or various other settings within first device 4 and second device 6.

Storage device 18 may be any type of storage device such as magnetic, electronic, or optical. Executable instructions stored in storage device 18 may be any instructions for use by first device 4 or second device 6. For example, the executable instructions may be instructions may be instructions for carrying out the method steps of the present invention method.

Preset condition 20 is any condition that includes as one of its components the distance 10 between first device 4 and second device 6. For example, preset condition 20 may be met by any distance 10 over 25 feet. Preset condition 20 may also include other components whereby distance 10 is varied according to, for example, the time or depth of the dive.

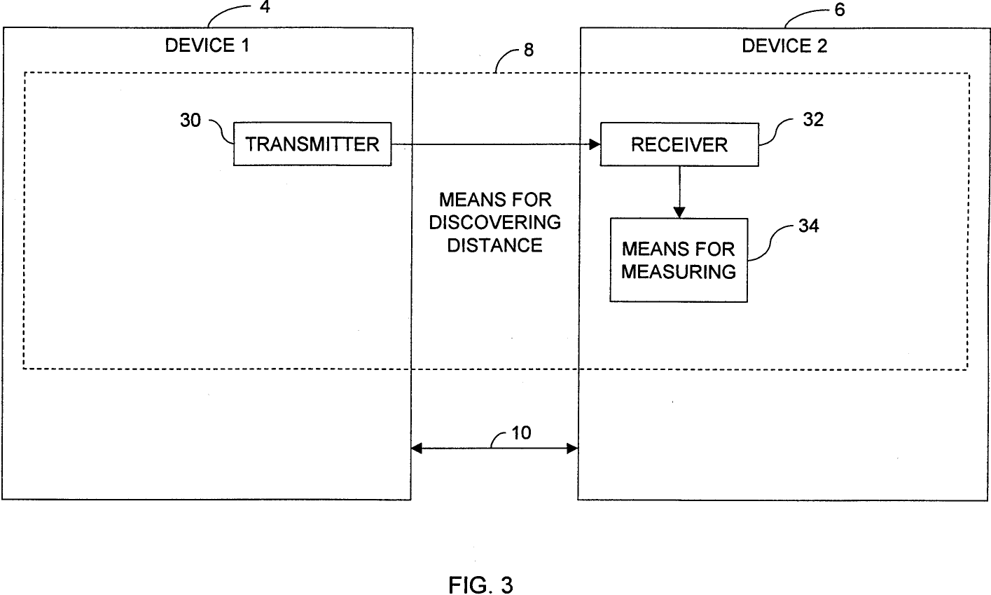

Means 8 for discovering distance 10 is any device or combination of devices for discovering the distance between first device 4 and second device 6. Figures 3, 5, and 7 illustrate various examples of devices for discovering distance 10.

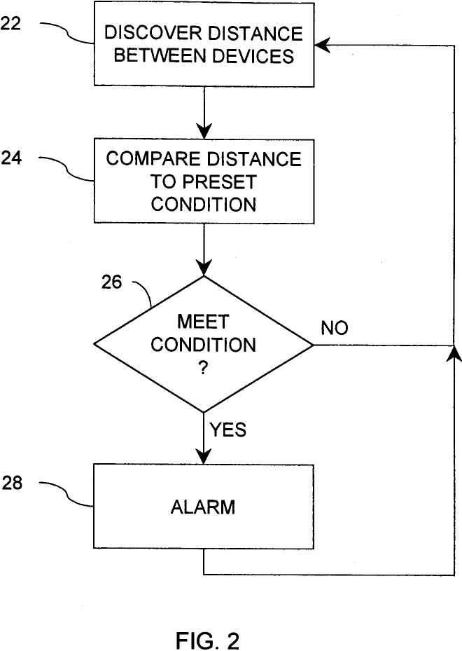

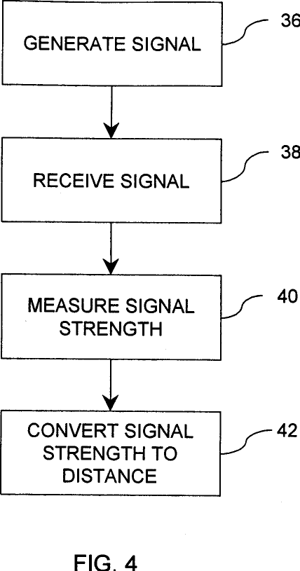

Figure 2 illustrates one embodiment of a method of the present invention for alerting when first device 4 and second device 6 are separated by a distance 10 that meets preset condition 20. Distance 10 is discovered 22 between first device 4 and second device 6. Distance 10 may be discovered through any means. Figures 4, 6, and 8 illustrate various examples of means for discovering distance 10.

Once distance 10 is discovered, it is then compared 24 to preset condition 20. If distance 10 does not meet 26 preset condition 20, in one embodiment, the process stops. In an alternate embodiment, the process loops and distance 10 between first device 4 and second device 6 is again discovered 22.

If distance 10 meets 26 preset condition 20, alarm 14 is activated 28. In one embodiment, alarm 14 remains active until manually reset. In an alternate embodiment, the method continues to loop and again discovers 22 distance 10 between first device 4 and second device 6. If the distance 10 no longer meets 26 preset condition 20, alarm 14 is deactivated.

Figure 3 is a block diagram illustrating one embodiment of means 8 for discovering distance. Means 8 for discovering distance 10 includes a transmitter 30, a receiver 32, and a means 34 for measuring. Transmitter 30 is any transmitter for generating a signal. In one embodiment, transmitter 30 is a transmitter for generating a radio frequency signal. Alternatively, transmitter 30 is a transmitter for generating a signal at any frequency. Receiver 32 is a receiver for receiving the signal generated by transmitter 30.

Means 34 for measuring is any combination of circuitry and executable instructions for measuring the signal strength of the signal received by receiver 32. Signal strength is any factor conveying a strength of a signal. For example, signal strength may include an amplitude of the signal or clarity of the signal.

Figure 4 illustrates a method for discovering distance 10 corresponding to the means 8 for discovering distance 10 illustrated in Figure 3. Transmitter 30 generates 36 a signal that is received 38 by receiver 32. The signal has an initial signal strength at first device 4. As the signal travels across distance 10 to second device 6, the signal strength of the signal is attenuated.

The signal strength is measured 40 at second device 6. The measured signal strength may be used as an indication of distance 10 or it may be converted 42 into another form of information indicative of distance 10. Converting 42 the measured signal strength into another form of information indicative of distance may be accomplished by any method. For example, it may be accomplished using a lookup table or by calculating distance 10 from a value indicating the measured signal strength.

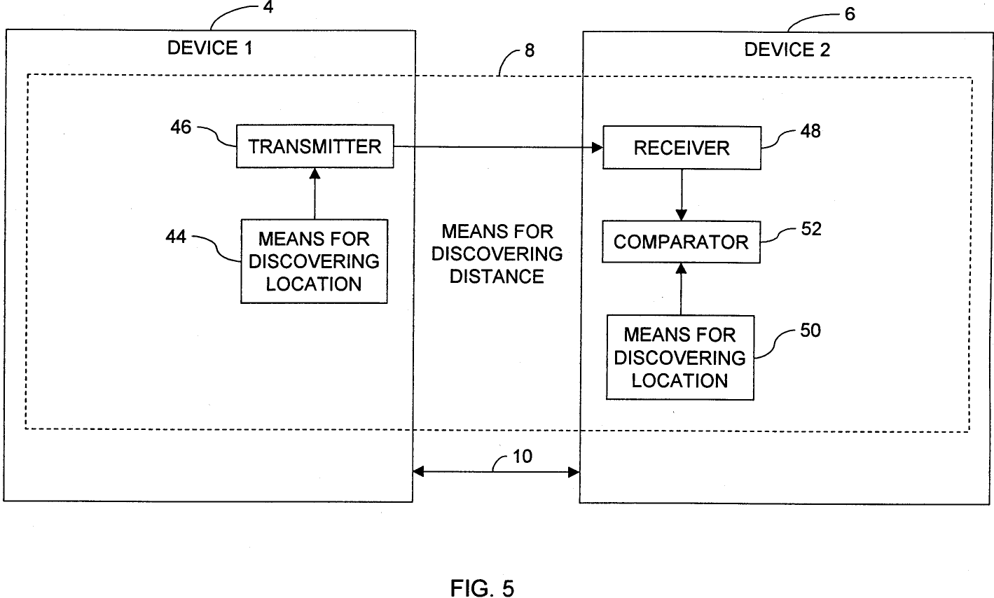

Figure 5 illustrates another embodiment of means 8 for discovering distance 10. Means 8 for discovering distance 10 includes a means 44 for discovering a location of first device 4, a transmitter 46, a receiver 48, a means 50 for discovering a location of second device 6, and a comparator 52.

Means 44, 50 for discovering the locations of first device 4 and second device 6 are any combination of circuitry and executable instructions for discovering the respective locations. For example, means 44, 50 for discovering the locations of first device 4 and second device 6 may be devices for discovering locations using triangulation.

Transmitter 46 is any transmitter for transmitting the location discovered by means 44 to receiver 48. Similarly, receiver is any receiver for receiving the location discovered by means 44 from transmitter 46.

Comparator 52 is any combination of circuitry and executable instructions for discovering distance 10 given the locations of first device 4 and second device 6.

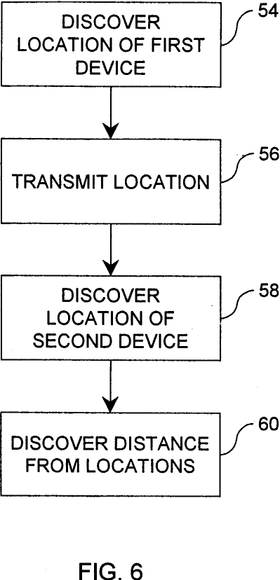

Figure 6 illustrates a method for discovering distance 10 corresponding to the means 8 for discovering distance 10 illustrated in Figure 5. Although the steps are presented in a specific order, the scope of the invention is not limited to the order in which the steps are performed, but rather which steps are performed.

Means 44 discovers 54 the location of first device 4. Transmitter 46 transmits 56 the location of first device 4 to receiver 48.Means 50 discovers the location for second device 6. Comparator 52 receives the locations of first device 4 and second device 6 and computes distance 10 between first device 4 and second device 6.

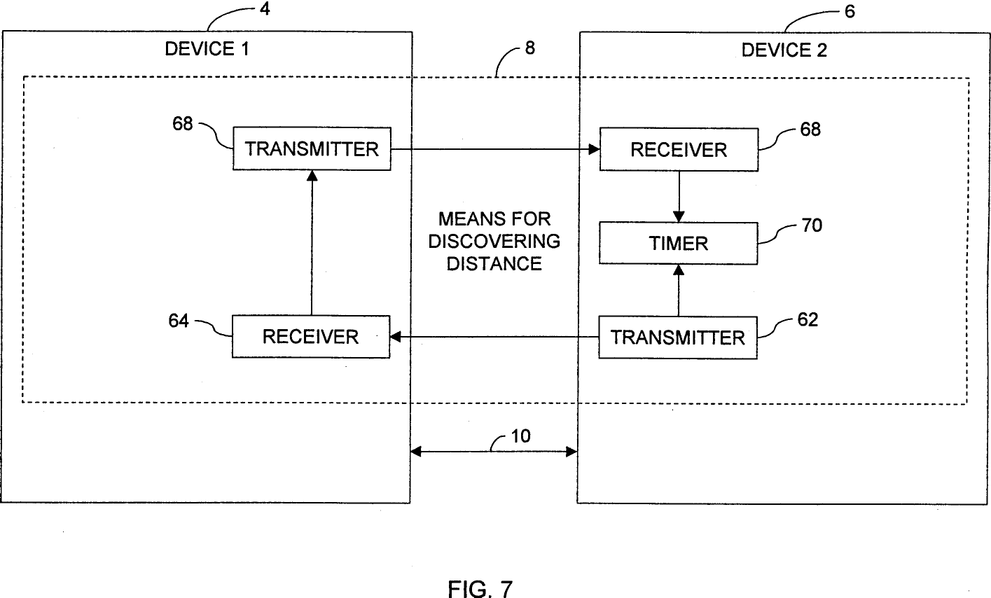

Figure 7 illustrates a third embodiment of means 8 for discovering distance 10. Means 8 for discovering distance 10 includes a first transmitter 62, a first receiver 64, a second transmitter 66, a second receiver 68, and a timer 70. First 62 and second 66 transmitters are any transmitters for transmitting a signal to first 64 and second 68 receivers, respectively. Likewise, First 64 and second 68 receivers are any receivers for receiving a signal from first 62 and second 66 transmitters, respectively.

Timer 70 is any timing device that may be started when transmitter 62 is activated to send a signal to receiver 64 and stopped when receiver 68 receives a signal from transmitter 66.

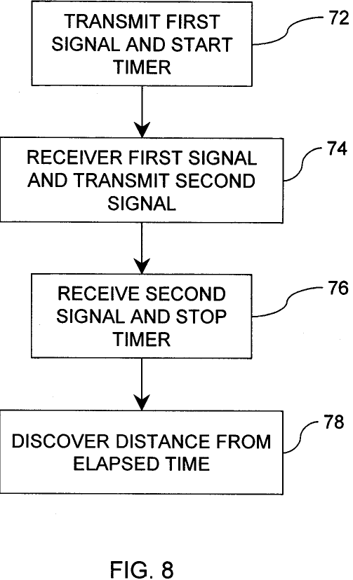

Figure 8 illustrates a method for discovering distance 10 corresponding to the means 8 for discovering distance 10 illustrated in Figure 5. First transmitter 62 transmits 72 a first signal that is received by receiver 64. Timer 70 is started at the time the first signal is transmitted. Upon receipt of the first signal, by first receiver 64, second transmitter 66 transmits 74 a second signal that is received 76 by second receiver 68. Upon receipt 76 of the second signal by second receiver 68, timer 70 stops. Distance 10 between first device 4 and second device 6 is discovered 78 from the time recorded by timer 70.

It should be understood that the foregoing description is only illustrative of the invention. Various alternatives and modifications may be devised by those skilled in the art without departing from the invention. For example, the present invention may incorporate a manually activated alarm that bypasses the comparison of distance 10 to preset condition 20 and activates alarm 14. Accordingly, the present invention is intended to embrace all such alternatives, modifications, and variances that fall within the scope of the appended claims.

Claims

1.A method for providing an alert when a distance between two devices exceeds a distance, the method comprising:
(a)first and second devices each discovering a distance between the first and second devices;
(b)the first device comparing the discovered distance to a first distance condition and alarming when the first distance condition is met by the discovered distance; and,
(c)the second device comparing the discovered distance to a second distance condition and alarming when the second distance condition is met by the discovered distance.

2.The method of claim 1 wherein discovering the distance includes:
(a)the first device generating a first signal having an initial signal strength and the second device generating a second signal having an initial signal strength, the signal strength of the first and second signals diminishing as the first and second signals travel between the first device and the second device;
(b)the second device receiving the first signal and the first device receiving the second signal;
(c)the second device measuring the signal strength of the received first signal and the first device measuring the signal strength of the received second signal; and,
(d)the second device discovering the distance from the measured first signal strength and the first device discovering the distance from the measured second signal strength.

3.The method of claim 2 wherein discovering the distance from the measured signal strength includes calculating the distance from the measured signal strength.

4.The method of claim 2 wherein discovering the distance from the measured signal strength includes comparing the measured signal strength to values in a table to discover the distance.

5.The method of claim 1 wherein discovering the distance includes:
(a)the first device discovering the location of the first device;
(b)the second device discovering the location of the second device;
(c)the first device transmitting the location of the first device to the second device and the second device transmitting the location of the second device to the first device; and,
(d)the first and second devices comparing the location of the first device to the location of the second device to discover the distance between the first device and the second device.

6.The method of claim 1 wherein discovering the distance includes:
(a)the second device requesting a response from the first device and the first device requesting a response from the second device;
(b)the first device responding to the second device and the second device responding to the first device;
(c)the first device measuring a first time between the request and receiving the response from the second device and the second device measuring a second time between the request and receiving the response from the first device; and,
(d)the first device discovering the distance from the first measured time and the second device discovering the distance from the second measured time.

7.The method of claim 1 wherein alarming includes generating a visible indication.

8.The method of claim 1 wherein alarming includes generating an audible indication.

9.A system for providing an alert when a distance between two devices exceeds a distance, the system comprising a first device and a second device, each device having:
(a) means for discovering a distance between the first and the second device;
(b)means for comparing the distance to a distance condition; and,
(c)means for alarming when the distance condition is met by the discovered distance.

10.The system of claim 9 wherein the means for discovering the distance includes:
(a)the first device having means for generating a first signal having an initial signal strength and the second device having means for generating a second signal having an initial signal strength, the signal strength of the first and second signals diminishing as the first and second signals travel between the first device and the second device;
(b)the second device having means for receiving the first signal and the first device having means for receiving the second signal;
(c)the second device having means for measuring the signal strength of the received first signal and the first device having means for measuring the signal strength of the received second signal; and,
(d)the second device having means for discovering the distance from the measured first signal strength and the first device having means for discovering the distance from the measured second signal strength.

11.The system of claim 10 wherein the means for discovering the distance from each measured signal strength includes means for calculating the distance from each measured signal strength.

12.The system of claim 10 wherein the means for discovering the distance from each measured signal strength includes:
(a)a table having values indicative of signal strength cross-referenced with values indicative of distance; and,
(b)means for comparing each measured signal strength to values in the table to discover the distance.

13.The system of claim 9 wherein the means for discovering the distance includes:
(a)the first device having means for discovering the location of the first device;
(b)the second device having means for discovering the location of the second device;
(c)the first device having means for transmitting the location of the first device to the second device and the second device having means for transmitting the location of the second device to the first device; and,
(d)the first and second devices each having means for comparing the location of the first device to the location of the second device to discover the distance between the first device and the second device.

14.The system of claim 9 wherein the means for alarming includes means for generating a visible indication.

15.The system of claim 9 wherein the means for alarming includes means for generating an audible indication.

16.The system of claim 9 further including:
(a)the first device having means for transmitting an alarm signal to the second device; and,
(b)the second device having means for alarming in response to the alarm signal.

17.The system of claim 16 wherein the first device further includes a user selection device for activating the means for transmitting the alarm signal to the second device.

18.The system of claim 9 wherein the means for discovering the distance includes:
(a)the second device having means for requesting a response from the first device and the first device having means for requesting a response from the second device;
(b)the first device having means for responding to the second device and the second device having means for responding to the first device;
(c)the first device having means for measuring a first time between the request and receiving the response from the second device and the second device having means for measuring a second time between the request and receiving the response from the first device; and,
(d)the first device having means for discovering the distance from the first measured time and the second device having means for discovering the distance from the second measured time.

19.A system for providing an alert when a distance between two devices exceeds a distance, the system comprising a first device and a second device, each device having:
(a)a signal generator;
(b)a signal receiver for receiving a signal from the other of the first and second devices;
(c)means for discovering, from a signal received from the other of the first and second devices, a distance between the first and second devices;
(d)means for comparing the distance to a distance condition; and,
(e)an alarm for alarming when the distance condition is met by the discovered distance.

20.The system of claim 19 wherein the signal generator includes means for generating a signal having an initial signal strength, the signal strength diminishing as the signal travels between the first device and the second device and wherein the means for discovering the distance includes:
(a)means for measuring the signal strength of the received signal; and,
(d)means for discovering the distance from the measured signal strength.

21.The system of claim 20 wherein the means for discovering the distance from the measured signal strength includes means for calculating the distance from the measured signal strength.

22.The system of claim 20 wherein the means for discovering the distance from the measured signal strength includes:
(a)a table having values indicative of signal strength cross-referenced with values indicative of distance; and,
(b)means for comparing the measured signal strength to values in the table to discover the distance.

23.The system of claim 19 wherein:
(a)the first device further includes means for discovering the location of the first device;
(b)the second device further includes means for discovering the location of the second device;
(c)the signal generator of the first device includes means for generating a signal indicative of the location of the first device and the signal generator of the second device includes means for generating a signal indicative of the location of the second device; and,
(d)the means for discovering the distance includes means for comparing the location of the first device to the location of the second device to discover the distance between the first device and the second device.

24.The system of claim 19 wherein the means for alarming includes means for generating a visible signal indication.

25.The system of claim 19 wherein the means for alarming includes means for generating an audible indication.

26.The system of claim 19 further including:
(a)the first device having means for transmitting an alarm signal to the second device; and,
(b)the second device having means for alarming in response to the alarm signal.

27.The system of claim 26 wherein the first device further includes a user selection device for activating the means for transmitting the alarm signal to the second device.

28.The system of claim 19 wherein the means for discovering the distance between the first and second devices includes:
(a)the second device having means for requesting a response from the first device and the first device having means for requesting a response from the second device;
(b)the signal generator including means for responding to a request for a response from the other of the first and second devices;
(c)the first device including means for measuring a first time between the request and receiving the response from the second device and the second device including means for measuring a second time between the request and receiving the response from the first device; and,
(d)the first device including means for discovering the distance from the first measured time and the second device including means for discovering the distance from the second measured time.
